(19) United States
(12) Patent Application Publication
(10) Pub. No.: US 2009/0319336 A1
(43) Pub. Date: Dec. 24, 2009

(54) DIAMOND VALUATION METHOD, APPARATUS AND COMPUTER READABLE MEDIUM PRODUCT

(75) Inventor: Dilip R. Mehta, Antwerp (BE)

Correspondence Address: Fleit Gibbons Gutman Bongini & Bianco PL, 21355 EAST DIXIE HIGHWAY, SUITE 115, MIAMI, FL, 33180, US

(73) Assignee: ROSY BLUE DMCC, Dubai (AE)

(21) Appl. No.: 12/444,446

(22) PCT Filed: Jul. 30, 2007
(86) PCT No.: PCT/US2007/074726

§ 371 Date: Aug. 12, 2009

Related U.S. Application Data
(60) Provisional application No. 60/828,981, filed on Oct. 11, 2006.

(51) Int. Cl. G06Q 50/00; G06Q 30/00; G06Q 10/00; G06F 17/30; G06F 17/40

(52) U.S. Cl. 705/10; 705/400; 707/104.1; 707/5; 707/E17.044; 707/E17.017

(57) ABSTRACT

Further it is an object of the present invention to provide a method for evaluating a diamond comprising the steps of selecting a diamond to value, determining the shape, size, color, clarity and cut of the selected diamond, determining a base price of the selected diamond, calculating the applicable discounts/premium for the parameters of the selected diamond, calculating a weightage for each parameter of the selected diamond for which a discount/premium is calculated, calculating a total adjusted price based on the discount/premium determined, the weightage determined and the base price determined in step d, and outputting the calculated total adjusted price. Further it is an object of the present invention to provide a method for determining the discounts/premium applicable to each parameter for a diamond—by selecting records of a given shape, size, color, clarity and cut—where the corresponding parameters are equal or within a specified small range, with the exception of parameter i and then determining the average sales price Y for a diamond for the ideal value V(0) of the selected parameter i, determining an average price Y(i) for a diamond with the selected parameter value of V(i), calculating a discount/premium D(i) of the selected diamond using the formula D(i)=(Y−Y(i))/Y, and repeating for each additional parameter V(i) determined. Further, the discount/premium with respect to the base/standard/index diamond, D′(i) is calculated as D′(i)=[D(i)−D(I)]/[1−D(I)] where D(I) is the discount/premium of the base/standard/index diamond. Further it is an object of the present invention to provide a method for determining the weightage for each parameter of the selected diamond by regression analysis for each parameter i.

### BACKGROUND OF THE INVENTION

1. Field of the Invention

The present invention relates to a method, apparatus and computer readable medium product for diamond valuation in order to determine the “true value” of a diamond.

2. Prior Art

Traditionally, the pricing for diamonds are broadly determined based on the shape and 4 C's—Carat, Cut, Color and Clarity. During trading, a customer determines the value of the diamond based on the 4 C's and his evaluation of the value of the diamond based on the observable physical characteristics of the diamond. As a result, there is an element of subjectivity involved in determining the value of a diamond.

Several different proposals have been suggested for valuing a diamond or other jewelry and objects of value, such as a painting or antique. Such proposals include one offered in a publication entitled A Valuation Model for Cut Diamonds, International Transactions in Operational Research, Vol. 12, Issue 4, Page 417 (July 2005) that acknowledges that cut diamonds are hard to value given the number and type of properties used in price construction. This describes an attempt to develop a valuation model for cut diamonds based on data published on the Internet, and employs regression trees (Classification and Regression Trees and Chi-Square Automatic Interaction Detection) and neural networks (using backpropagation) for this purpose. In assessing its performance, the article notes that the results obtained may prove to have some advantages over the Rapaport price lists (an industry-wide adopted price indicator).

US2004/00305565A1 describes systems and methods for describing valuable items. More particularly, the invention described relates to data processing systems and methods for appraising and otherwise evaluating the value of and describing jewelry and other items, and for providing information relating to such items for use in analyzing insurance underwriting, claims analysis, and similar issues.

U.S. Pat. No. 6,304,853 describes an automated gemstone evaluation system comprising an input device for receiving gemstone data, a processing device for generating an evaluation report including a pricing estimate, based upon the gemstone data received, and an output device for communicating the evaluation report to the user. Preferably the evaluation report includes a summary description of the gemstone.

U.S. Pat. No. 6,038,554 describes a non-subjective method of valuing using a computer-assisted valuing system for discovering both an entity's actual current societal monetary value and its contemporary monetary worth specifically to an inquiring individual person. A target entity's retail and wholesale prices are provided along with its true worth and specific value to the explorer. The invention employing as yardstick the NORM, which is the hypothetical unit in any group that is accurately calculated to be both precisely average in every one of its collectively discoverable characteristics and its price, enabling a prospective trader objectively to compare the contemporary monetary values of any and all competing units in or out of any probed group, regardless of such competing units' respective current prices.

Despite all prior efforts to develop a viable system or method, apparatus and product for obtaining the “true value” of a diamond, thus far, none have been successful.

### SUMMARY OF THE INVENTION

It is a principal object of the present invention to provide a method, apparatus and computer readable medium product for valuing diamonds using a novel and effective matrix. The diamond valuation matrix, according to the present invention evaluates a diamond based on the 4 C's and a plurality of specific physical characteristics—all of which have a bearing on the diamond value. After evaluating a specific diamond against a matrix that includes algorithms for determining the effect on price of specific physical characteristics, the invention determines a “true price” for the diamond. Traders and diamond manufacturers can then use this “true price” in their trading process and thereby ensure a fair trade.

In addition, the method, apparatus and computer readable medium product of the present invention can also be used as a decision tool by diamond manufacturers, in order to determine the optimum manufacturing technique to obtain the “best value” for a diamond—after considering the trade-offs involved in diamond polishing losses vis-à-vis increased prices.

Further it is an object of the present invention to provide a method for evaluating a diamond comprising the steps of selecting a diamond to value, determining the shape, size, color, clarity and cut of the selected diamond, determining the details of the diamond for all the other parameters, establishing a transaction database of data records of recent diamond transactions containing details of the shape, size, color, clarity and cut of the diamonds transacted and details of a plurality or multiplicity of other parameters of the diamonds transacted, determining a base diamond whose price will be the base price, calculating the applicable discounts/premium to be allocated for each of the parameters based on the parameter value for the diamond, calculating the weighted total adjustment where discount/premium for each parameter is multiplied with the weightage associated with the parameter and the sum of the weighted discount/premium is taken as the weighted total adjustment, and outputting the calculated total adjusted price.

It is a further object of the present invention to provide a method of determining a discount/premium for a diamond that comprises the steps of: selecting a diamond to value, determining the shape, size, color, clarity and cut of the selected diamond, establishing a transaction database of data records of recent diamond transactions containing details of the shape, size, color, clarity and cut of the diamonds transacted and details of a plurality or multiplicity of other parameters of the diamonds transacted, Selecting transactions from the database where the values for each parameter, apart from that for parameter i, are the same across transactions or within a specified range of each other. For this parameter, i—determining the average sales price Y for a diamond for the ideal value V(0) of the selected parameter i, determining the average sales price Y(i) for the diamonds with the selected parameter value V(i), calculating a discount/premium D(i) of the selected diamond using the formula D(i)=(Y−Y(i))/Y. and repeating for each additional parameter i.

D(i) is taken as a discount with respect to an ideal diamond for that parameter. Hence, note that, the discounts/premium that are actually used in the equation, D′(i)—will depend on D(i) as well as the diamond which is going to be defined as the base diamond/standard diamond/index diamond. If the base/standard/index diamond has a discount as obtained from the database records as shown above, D(I), then D′(i)=[D(i)−D(I)]/[1−D(I)]. Thus, our method provides the flexibility to select any diamond as a base/standard/index diamond and accordingly value any diamond with respect to the base/standard/index diamond as per the equation above.

Note that if D(i)<D(I)—it indicates a premium over the base diamond/standard diamond/index diamond.

The above method for determining a discount/premium can include calculating a weightage factor for each of the parameters V(i) determined. The weightage factor is determined, preferably, by regression analysis for each parameter V(i). The method can also include maintaining and updating a database of the discount/premium factors, and/or maintaining and updating a database of the weightage factors.

Still further, it is an object of the present invention to provide apparatus for evaluating a diamond comprising: means for establishing a transaction database of data records of recent diamond transactions containing details of the shape, size, color, clarity and cut of the diamonds transacted and details of a plurality or multiplicity of other parameters of the diamonds transacted, means for determining the base price based on a base/standard/index diamond, means for calculating a discount/premium for each parameter from the discounts/premium database depending on the value of the parameters for the diamond, means for calculating a weightage for each parameter of the selected diamond for which a discount/premium is calculated, means for calculating a total adjusted price based on the discount/premiums determined, the weightages determined and the base price determined, and means for outputting the calculated total adjusted price.

Further, the apparatus above may include for the means for calculating a discount/premium for each parameter, means for selecting transactions for each parameter i—where all the other parameter values apart from parameter i—in the transactions are equal or within a specified range of each other, means for determining the average sales price Y for a diamond for the ideal value V(0) of the selected parameter i, means for determining an average price Y(i) for a diamond with the selected parameter value of V(i) for parameter i, and means for calculating a discount/premium D(i) of the selected diamond using the formula D(i)=(Y−Y(i))/Y for parameter value V(i). D(i) is taken as a discount with respect to an ideal diamond for that parameter. Hence, note that, the discounts/premium that are actually used in the equation, D′(i)—will depend on D(i) as well as the diamond whose value is going to be defined as the base diamond/standard diamond/index diamond. If the base/standard/index diamond has a discount as obtained from the database records as shown above, D(I), then D′(i)=[D(i)−D(I)]/[1−D(I)]. Thus, our method provides the flexibility to select any diamond as a base/standard/index diamond and accordingly value any diamond with respect to the base/standard/index diamond as per the equation above.

Note that if D(i)<D(I)—it indicates a premium over the base diamond/standard diamond/index diamond.

Also, the apparatus may include for the means for calculating a weightage for each parameter of the selected diamond for which a discount/premium is calculated, means for determining the weightage by regression analysis for each parameter V(i). The apparatus can also including means for updating a database of the discount/premiums and/or means for updating a database of the weightages.

Still further, the apparatus for determining a discount/premium for a diamond may comprise means for establishing a transaction database of data records of recent diamond transactions containing details of the shape, size, color, clarity and cut of the diamonds transacted and details of a plurality or multiplicity of other parameters of the diamonds transacted; means for selecting transactions for each parameter i—where all the other parameter values apart from parameter i—in the transactions are equal or within a specified range of each other; means for determining the average sales price Y for a diamond for the ideal value V(0) of the selected parameter i; means for determining an average price Y(i) for a diamond with the selected parameter value of V(i); means for calculating a discount/premium factor D(i) of the selected diamond using the formula D(i)=(Y−Y(i))/Y; means for repeating for each parameter i, and means for outputting the discount/premium factors. D(i) is taken as a discount with respect to an ideal diamond for that parameter. Hence, note that, the discounts/premium D′(i)—will depend on D(i) as well as the diamond whose value is going to be defined as the base diamond/standard diamond/index diamond. If the base/standard/index diamond has a discount as obtained from the database records as shown above, D(I), then D′(i)=[D(i)−D(I)]/[1−D(I)]. Thus, our method provides the flexibility to select any diamond as a base/standard/index diamond and accordingly value any diamond with respect to the base/standard/index diamond as per the equation above.

Note that if D(i)<D(I)—it indicates a premium over the base diamond/standard diamond/index diamond.

The above apparatus may include means for calculating a weightage factor for each of the parameters V(i). The weightage factor may be determined by regression analysis for each parameter V(i). Also, a database of the discount/premium factors can be maintained and updated, and/or a database of the weightage factors can be maintained and updated.

It is another object of the present invention to provide a computer-readable medium product containing program instructions for evaluating a diamond by establishing a transaction database of data records of recent diamond transactions containing details of the shape, size, color, clarity and cut of the diamonds transacted and details of a plurality or multiplicity of other parameters of the diamonds transacted, determining a base price of the selected diamond, calculating a discount/premium for each parameter from the discount/premium database depending on the parameter value for the selected diamond, calculating a weightage for each parameter of the selected diamond for which a discount/premium is calculated, calculating a total adjusted price based on the discount/premiums determined, the weightage determined and the base price determined, and outputting the calculated total adjusted price.

The computer-readable medium can include program instructions for carrying out the determination of discount/premiums by selecting data records where for each parameter i, all the other parameters are equal or within a specified range of each other, and for this parameter i—from these selected records, determining the average sales price Y for a diamond for the ideal value V(0) of the selected parameter i, determining an average price Y(i) for a diamond with the selected parameter value of V(i), calculating a discount/premium D(i) of the selected diamond using the formula D(i)=(Y−Y(i))/Y, and repeating for each additional parameter V(i) determined. D(i) is taken as a discount with respect to an ideal diamond for that parameter. Hence, note that, the discounts/premium D′(i)—will depend on D(i) as well as the diamond whose value is going to be defined as the base diamond/standard diamond/index diamond. If the base/standard/index diamond has a discount as obtained from the database records as shown above, D(I), then D′(i)=[D(i)−D(I)]/[1−D(I)]. Thus, our method provides the flexibility to select any diamond as a base/standard/index diamond and accordingly value any diamond with respect to the base/standard/index diamond as per the equation above.

Note that if D(i)<D(I)—it indicates a premium over the base diamond/standard diamond/index diamond.

The computer-readable medium can include program instructions wherein the weightage is determined by regression analysis for each parameter V(i). The computer-readable medium can include program instructions for maintaining and updating a database of the discount/premiums, and/or program instructions for maintaining and updating a database of the weightages.

The above uses and other applications of the method, apparatus and computer-readable medium product of the present invention, as well as, further objects and advantages of the present invention, will become more evident from the following detailed description of the present invention when taken in conjunction with the appended drawings.

### BRIEF DESCRIPTION OF THE DRAWINGS

FIG. 1 shows a process flow chart of the method, apparatus and product for determining value of a diamond.

FIG. 2 shows a process flow chart of a subroutine providing an algorithm for determining discount/premium factors, D′(i) with respect to the base/standard/index diamond.

FIG. 3 shows a process flow chart of a subroutine providing an algorithm for determining weightages, W(i).

FIG. 4 shows a context flow diagram of the present invention.

FIG. 5 shows a data flow chart of the price estimation subroutine.

FIG. 6 shows a data flow chart of the discount/premium calculation subroutine.

FIG. 7 shows a data flow chart of the weights calculation subroutine.

FIG. 8 is a block diagram of a computer system useful for implementing an embodiment of the present invention.

### DETAILED DESCRIPTION OF PREFERRED EMBODIMENTS OF THE INVENTION

Currently, the pricing is based on the shape of the diamond and the 4 Cs—Carat, Cut, Color and Clarity. The present invention employs a Diamond Valuation Matrix that uses an exhaustive approach to determine the true value of a diamond. In addition to the 4 Cs, the matrix incorporates an exhaustive list of physical characteristics of the diamond to determine the true value. The physical characteristics that are considered are listed in Table 1, as follows:

TABLE 1
List of Physical Characteristics to be used in the Valuation Matrix

| Parameter | Description | Measurement Criteria |
|---|---|---|
| Shape | Shape of the diamond - For | |
| | e.g., Round, Princess, | |
| | Marquise, Pear etc | |
| Color | Color of the diamond - For | |
| | e.g., D, E, F, G, . . . | |
| Clarity | Clarity of the diamond - For | |
| | e.g., IF, VVS1, VVS2, VS1, | |
| | VS2, SI1, SI2, SI3, I1, I2, I3 | |
| Cut | Make of the diamond - For e.g. | |
| | Excellent, Ideal, Heart & Arrow, | |
| | AGS0000 | |
| Polish | Visibility of polish lines under a | Grades include the following: |
| | 10× microscope | Excellent, Very Good, Good, Fair |
| Symmetry | Symmetry of the diamond vis- | Grades include the following: |
| | à-vis each facet | Excellent, Very Good, Good, Fair |
| Fluorescence | Fluorescence as seen in | Grades include the following: |
| | ultraviolet lighting | None, Slight, Medium, Strong, |
| | | Very Strong |
| Milkiness | Cloudiness present in the | Grades include the following: |
| | diamond | None, Very slightly, Slightly, |
| | | Medium, Medium Heavy, Heavy, |
| | | Very Heavy, Strong |
| Brilliance | The extent of reflected light in | Grades include the following: |
| | the diamond | Excellent, Very Good, Good, Fair |
| Shades | Color hue of the diamond | Values include the following: |
| | | Yellow, Brown, Pink, Purple etc |
| Inclusion dispersion | The extent to which inclusions | Average distance between |
| pattern | are concentrated in the | inclusions as % of table size |
| | diamond | |
| Table Inclusions | Inclusions seen from the table | Average distance of table |
| position | of the diamond | inclusions from the table center |
| | | as a % of table size |
| Table Inclusions | Number of inclusions that are | Number of inclusions seen from |
| percentage | seen from the table of the | the table as % of total inclusions |
| | diamond | that are seen from the table |
| Number of | Presence of inclusions in the | Total number of inclusions in the |
| Inclusions | diamond | diamond |
| Open Inclusions | Number of inclusions that are | Number of open inclusions as a |
| Percentage | open inclusions | % of total number of inclusions |
| Open inclusions on | Extent of open inclusions as | Area of the open inclusions as a |
| Table | seen on the table of the | % of the total surface area of the |
| | diamond | table |
| Open Inclusions on | Extent of open inclusions as | Area of the open inclusions as a |
| Pavilion | seen on the pavilion side of the | % of the total surface area of the |
| | diamond | pavilion |
| Black Inclusions | Number of inclusions that are | Number of black inclusions as a |
| Percentage | black inclusions | % of total number of inclusions |
| Black Inclusions on | Distance of the black inclusions | Average distance of black |
| Table | from the table center | inclusions from the center of the |
| | | table |
| Black Inclusions on | Distance of the black inclusions | Average distance of black |
| Pavilion | from the culet | inclusions from the culet |
| Internal Graining | Extent of internal graining | Grades include the following: |
| | | None, Slight, Medium, Heavy |
| Included Crystals | Presence of included crystals | Total number of included crystals |
| | | in the diamond |
| Dark Included | Presence of dark included | Total number of dark included |
| Crystals | crystals | crystals in the diamond |
| Indented Naturals | Presence of Indented Naturals | Area of indented natural |
| Scratches | Presence of scratches on the | Grades include the following: |
| | surface of the diamond | None, Slight, Medium, Heavy |
| Proportions - | Table %, Pavilion %, Crown | Cut grades include Ideal, |
| Table % | angle, Girdle thickness, Depth | Excellent, Good, Fair, Hearts |
| Proportions - | % are used to determine the | and Arrows |
| Pavilion % | cut of the diamond | |
| Crown angle | | |
| Girdle thickness | | |
| Depth % | | |
| Culet Size | Size of the culet of the diamond | Grades include the following: |
| | | Pointed, Very Small, Small, |
| | | Medium, Large, Abraded, |
| | | Chipped |
| Extra Facets | Presence of extra facets on the | Number of extra facets on the |
| | diamond | diamond |

Note that, in addition to the above parameters listed in Table 1, the matrix will also frequently be updated to incorporate any new parameters that may have an impact on the pricing of a diamond. The invention (algorithms) is scalable and will adapt to new parameters being included to value the diamond.

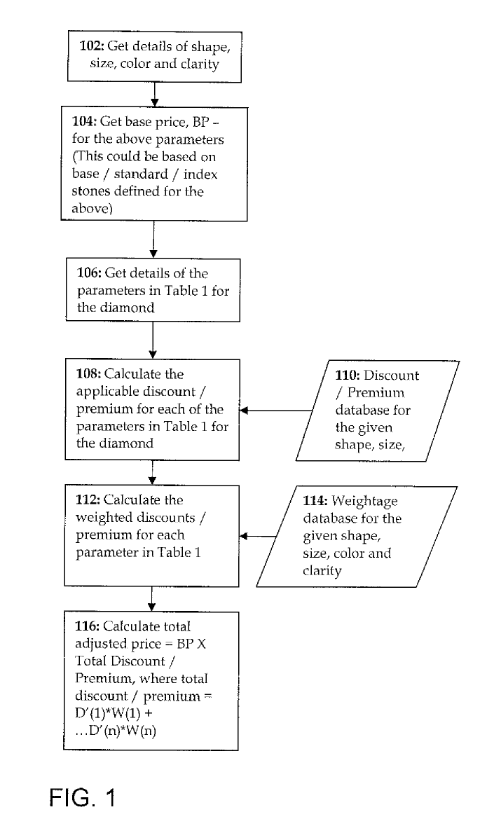

The algorithms used in the method, apparatus and product of the present invention to determine the true value of the diamond, based on the above parameters is as follows Referring now to FIG. 1, shown is a process flow chart of the method, apparatus and product for determining value of a diamond.

In step 102, the details about shape, size, color, clarity and cut are obtained for a diamond whose price is to be determined, and the output goes to step 104. In step 104, relevant information is selected from a lookup table that provides a correlation between the parameters obtained in step 102 and standard pricing. In step 104, the base price, BP, is calculated as the average sales price for a representative diamond in each buckets of shape, size, color, clarity and cut—the base price thus represents the price of the base/standard/index diamond in each bucket—and is used as the base price over which the discount/premium of the diamond to be valued is calculated, and the output goes to step 106. In step 106, the details of parameters of the diamond under consideration, as listed in Table 1, are obtained and input; Table 1 is included as a lookup table in block 118 with an input to step 106. In step 108, the applicable discount/premium is calculated for the diamond under consideration for each of the relevant parameters of Table 1 using an input from a discount/premium database in block 110 for the given shape, size, color and clarity. The discount/premiums are stored in block 110.

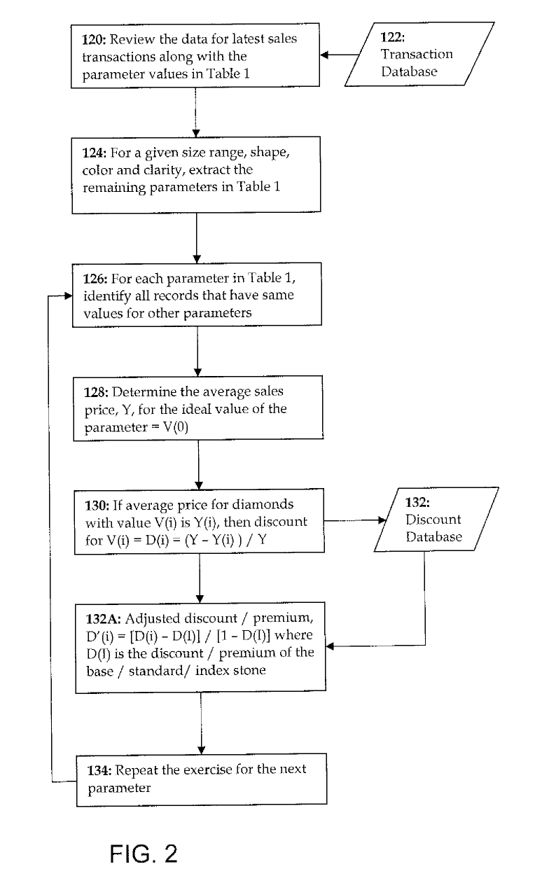

FIG. 2 shows a process flow chart of a subroutine of step 108 of FIG. 1, and provides an algorithm for determining discount/premium factors, D(i), to determine the discount/premiums for a diamond of given shape, size range, color range, clarity range and cut and the applicable relevant discount/premiums for various ranges of values of parameters (i) shown in Table 1, This subroutine will be discussed in more detail hereinafter.

Reverting to FIG. 1, in step 112, the weighted discount/premiums for the parameters listed in Table 1 are calculated using as an input a weightage database in block 114 for the given shape, size, color and clarity. The discount/premiums of step 108 and the weighted discount/premiums are output to step 116 and stored in block 114.

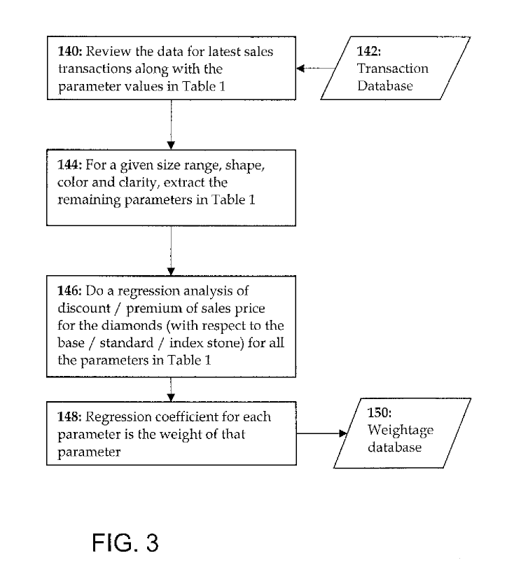

FIG. 3 shows a process flow chart of a subroutine of step 112 of FIG. 1, and provides an algorithm for determining weightages, W(i), to determine the discount/premium for weightage for a given shape, size range, color range, clarity range and cut, and for the weightages (relative importance) of the relevant parameters shown in Table 1. This subroutine will be discussed in more detail hereinafter.

Reverting to FIG. 1, in step 116, first, the total discount/premium (TD) is calculated according to the formula:

TD=D′(1)*W(1)+D′(2)*W(2)+ . . . +D′(n)*W(n).

Where, D′(i) is the discount/premium for the parameter i for the selected diamond with respect to that of the base diamond/standard diamond/index diamond.

Then, the total adjusted price or Net Price (NP) is calculated and is equal to the base price BP times the total discount/premium derived from steps 108 and 112.

Accordingly, the net price that represents the true value of the diamond is given by the formula:

Net Price=BP*TD.

Thereafter, the total adjusted price or Net Price is output either to a printer, a display, a memory, or communicated to a remote point via telecommunication, and intranet or the Internet.

Summarizing the above, an algorithm is provided that will be used every time a user wants to determine the true value of a diamond. The algorithm comprises the following steps:
Step 1 For a diamond whose price is to be determined, obtain the details about shape, size, color, clarity and cut.
Step 2 For the diamond to be priced, obtain the remaining information as in Table 1.
Step 3 Calculate the base price, BP, as the average sales price for a base/standard/index diamond for a given shape, size, color, clarity and cut.
Step 4 Apply a matrix comprising the following databases:
   a. Discount/premiums: For a given shape, size range, color range, clarity range and cut—this database contains the applicable discount/premiums for various ranges of values of relevant parameters shown in Table 1
   b. Weightage: For a given shape, size range, color range, clarity range and cut—this database contains the weightages (relative importance) of the relevant parameters shown in Table 1
      Step 5 For a diamond of a given shape, size range, color range, clarity range and cut—let the discount/premiums as picked in Step 4a be D′(1), D′(2), D′(3), . . . , D′(n)—where D(i) represents the applicable discount/premium for parameter (i) in Table 1 with respect to the base/standard/index diamond. If D(i) is taken as a discount with respect to an ideal diamond for that parameter, the discounts/premium D′(i)—will depend on D(i) as well as the diamond whose value is going to be defined as the base diamond/standard diamond/index diamond. If the base/standard/index diamond has a discount as obtained from the database records as shown above, D(I), then D′(i)=[D(i)−D(I)]/[1−D(I)]. Thus, our method provides the flexibility to select any diamond as a base/standard/index diamond and accordingly value any diamond with respect to the base/standard/index diamond as per the equation above.

Note that if D(i)<D(i)—it indicates a premium over the base diamond/standard diamond/index diamond.
Step 6 For a diamond of a given shape, size range, color range, clarity range and cut—let the weightages as picked in Step 4b be W(1), W(2), W(3), . . . , W(n)—where W(i) represents the weightage for parameter (i) in Table 1.
Step 7 The total discount/premium, TD=D′(1)*W(1)+D′(2)*W(2)+ . . . +D′(n)*W(n)
Step 8 The net price that represents the true value of the diamond is given by the formula:

Net Price=BP*TD(from Step 7)

Referring now particularly to FIG. 2, the subroutine for determining discount/premiums attributable to the parameters of Table 1 will be described. The algorithm described will be used as part of a periodic database update. The algorithm is used to determine and store the discount/premium factor to be calculated based on the value of a given parameter in Table 1.

In step 120, data records for the latest 500 sales transactions of diamonds, along with the values of the parameters mentioned in Table 1, is stored in a transaction database in block 122. Data records from block 122 are retrieved and reviewed in step 120. The latest 500 sales or transactions of diamonds are kept in storage in the transaction database of block 122 together with the parameter values of Table 1, and constantly updated. The number of transactions considered can be increased later from the current value of 500, as the database grows in size.

In step 124, the data records are compared with the diamond under consideration to segregate and extract those data records which match, i.e. are the same as or closely approximate the diamond under consideration with respect to its given shape, size range, color range, clarity range and cut. For the data records extracted as above, in Step 126—the discount/premium is obtained for each parameter i in Table 1 as follows: Extract records from the above where values of all parameters apart from i. are equal or within a reasonably small range.

Then in step 128, from the records identified above, the discount/premium for parameter (i) is processed as follows. Let the sales price be Y(i) and the value of the parameter (i), be V(i). Since the remaining parameters are the same or within a reasonably small range, the variation in price Y(i) is mainly dependent on the variation in V(i). Let the price be Y for the ideal value of V(0). (Ideal value of V(i) is defined as the value which would be applicable to a flawless diamond for that particular parameter. Thus, if the parameter being considered is black inclusions %—the ideal value of the parameter would be 0 as there would be no black inclusions in a flawless diamond). The determined average sales price Y for the ideal value of the parameter V(0) is output and is passed to step 130.

In step 130, let Y(i) be the average price of a diamond where the value of parameter (i) is V(i). Then, discount/premium D(i) for V(i) is D(i)=(Y−Y(i))/Y. This is stored in a discount/premium database 132.

D(i) is taken as a discount with respect to an ideal diamond for that parameter. Hence, note that, the discounts/premium D′(i)—will depend on D(i) as well as the diamond whose value is going to be defined as the base diamond/standard diamond/index diamond. If the base/standard/index diamond has a discount as obtained from the database records as shown above, D(I), then D′(i)=[D(i)−D(I)]/[1−D(I)]. Thus, our method provides the flexibility to select any diamond as a base/standard/index diamond and accordingly value any diamond with respect to the base/standard/index diamond as per the equation above. This is done in Step 132A.

Note that if D(i)<D(I)—it indicates a premium over the base diamond/standard diamond/index diamond.

Next, the subroutine in step 134 loops back to step 126 and the exercise is repeated for the next parameter (i), and the processing steps continue until all parameters have been processed.

Referring now particularly to FIG. 3, the subroutine for determining discount/premiums due to weightage W(i) will be described. The algorithm described will be used as part of a periodic database update, and the algorithm is used to determine the weightage calculated for each parameter in Table 1. In step 140, the transaction database 142 is reviewed for the latest sales transactions (e.g., 500 transactions) of diamonds, along with the parameter values in Table 1. The number of transactions considered can be increased later from the current value of 500, as the database grows in size.

For a diamond of a given shape, size range, color range and clarity range—let the weightages be W(1), W(2), W(3), . . . , W(n)—where W(i) represents the weightage for parameter (i) in Table 1.

In step 144, for a given shape, size range, color range, clarity range and cut—isolate or extract the remaining parameters as described in Table 1, in the manner as described with respect to FIG. 2, leaving only the non-matching parameters (i). Alternatively, use the output of step 124 of FIG. 2 as an input to step 146.

For the records obtained in steps 142 and 144 above, let the discount/premium over the standard base price be DY and the discount/premium value of the parameter (i) be D′(i). In step 146 a regression analysis is performed (using known mathematical techniques) on DY and V(i) values, to derive the equation: DY=w(1)*D′(1)+w(2)*D′(2)+ . . . +w(n)*D′(n)+Constant.

The value, w(i) is the regression coefficient for each parameter (i), and will be the weightage for the parameter (i). This is the output obtained in step 148 and stored in weightage database 150.

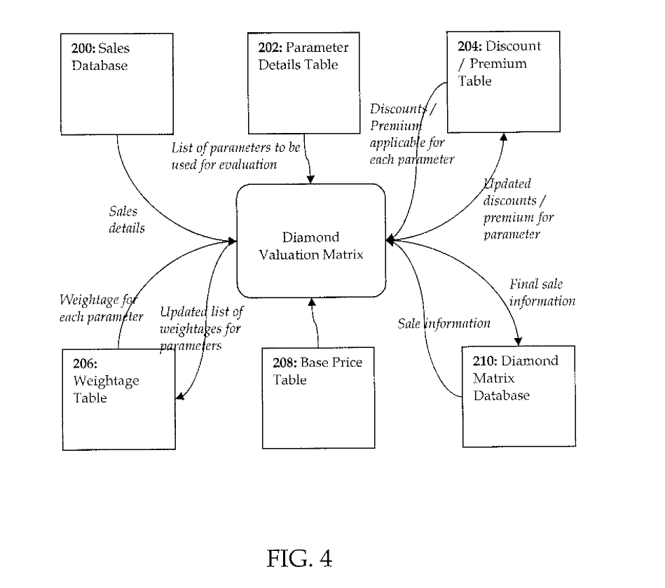

Turning now to FIG. 4, a context flow diagram is shown of the present invention. As shown, block 200 is a sales database consisting of all the final sales transactions. Block 202 is a parameter details table like Table 1. Block 204 is a discount/premium database or table. Block 206 is a weightage database or table. Block 208 is a base price table and contains sales prices derived from indices defined as say, average strike prices of transactions for a diamond with a given size, color, clarity and cut. Block 210 is a Diamond Matrix Database that contains final sales information as determined by the invention. Block 212 is the Diamond Valuation Matrix as described in conjunction with FIGS. 1 to 3. The context flow is as previously described. Information and data is passed from blocks 200 to 210 to the Diamond Valuation Matrix 212, and data is passed back to the discount/premium table 204, weightage table 206 and Diamond Matrix Database 210 to update. Also, each of blocks 200, 202 and 208 are periodically updated.

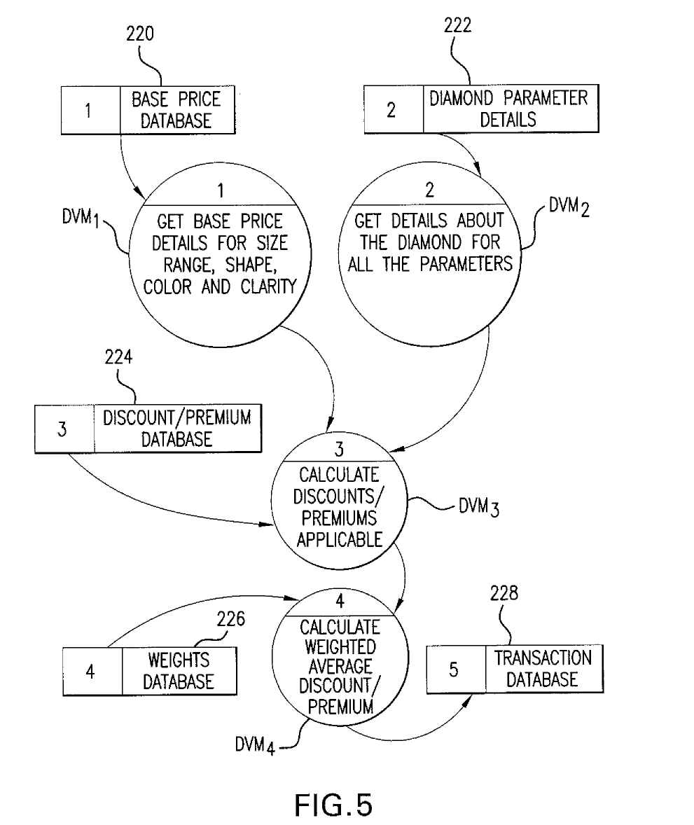

FIG. 5 shows a data flow chart of the price estimation subroutine. The circles represent functional activity of the Diamond Valuation Matrix (DVM). The base price database 220 sends base price details 222 for size range, shape, color, clarity and cut to DVM₁. Diamond parameter details are sent to DVM₂. The outputs of DVM₁ and DVM₂ and data from the discount/premium database 224 are sent to the DVM₃, where applicable discount/premiums are calculated for each relevant parameter (i). The output of DVM₃ and data from the weights database 226 are sent to DVM₄, where the weighted average discount/premium is calculated for each relevant parameter (i). The output of DVM₄ is sent to the transaction database 228. In a final function (not illustrated in this figure, the net price is calculated as described.

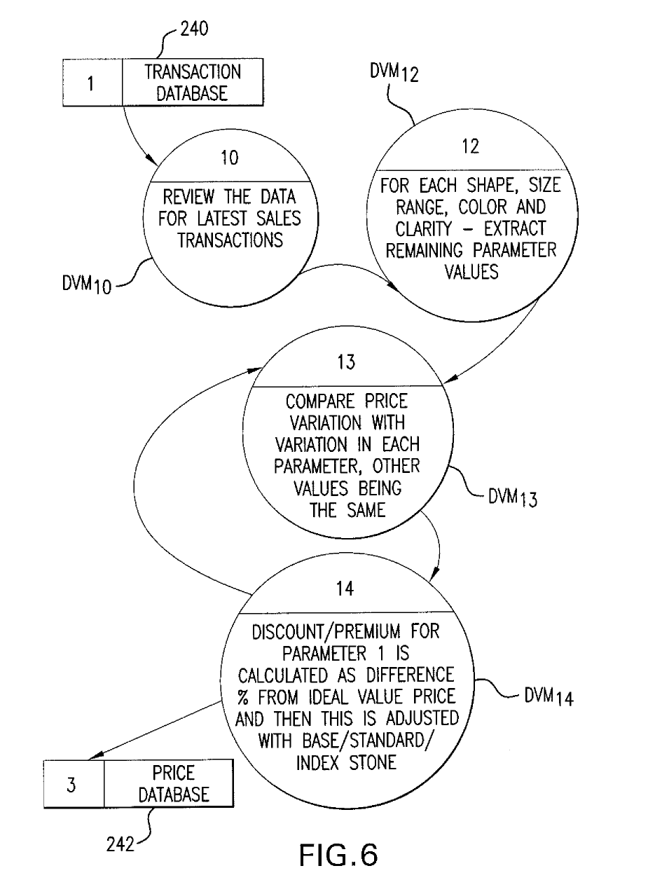

FIG. 6 shows a data flow chart of the discount/premium calculation subroutine. The circles in the figure represent functional activity of the Diamond Valuation Matrix (DVM). Transaction database 240 sends data to DVM₁₀, where the data of latest sales transactions is reviewed. After processing as described above, an output is sent to DVM₁₂, where relevant parameters (i) are extracted for diamonds of the same shape, size range, color, clarity and cut as the subject diamond under consideration. The output of DVM₁₂ is sent to DVM₁₃, where price variations are compared for each parameter (i), as described above. The output of DVM₁₃ is then sent to DVM₁₄ where the discount/premium attributable for each parameter (i) is calculated as difference % from ideal value price and the output is sent and stored in the price database 242, as described.

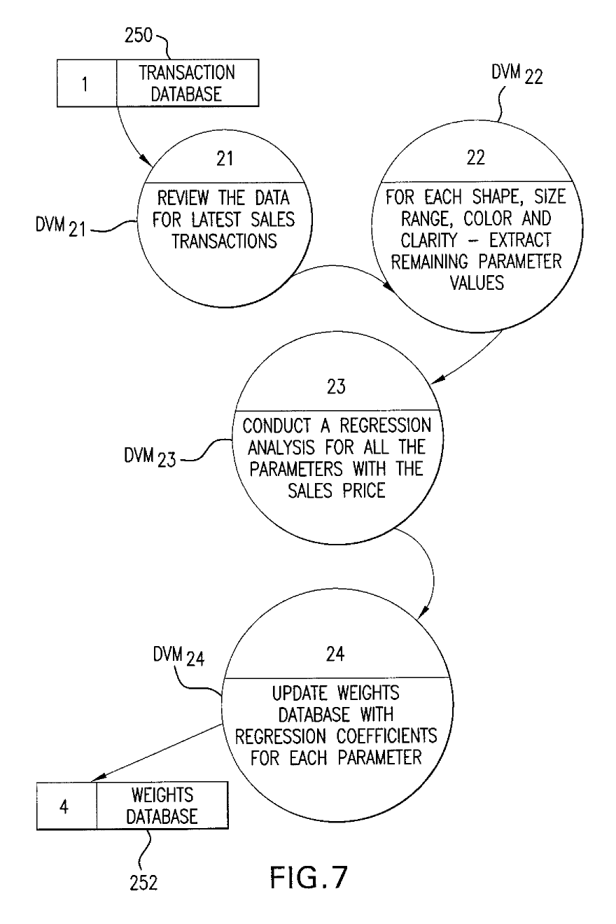

FIG. 7 shows a data flow chart of the weights calculation subroutine. The circles in the figure represent functional activity of the Diamond Valuation Matrix (DVM). The output of transaction database 250 is sent to DVM₂₁, where the data for the latest sales transactions are reviewed. The output of DVM₂₁ is passed to DVM₂₂ where relevant parameters (i) are extracted for diamonds of the same shape, size range, color and clarity as the subject diamond under consideration. The output of DVM₂₂ is sent to DVM₂₃ where a regression analysis is conducted for the parameters (i) vis-à-vis sales price. The output of DVM₂₃ is sent to DVM₂₄ where the weights database is updated with regression coefficients for each parameter (i), as described.

Usage of the invention—Daily usage—The matrix will be used on a daily basis by diamond traders to determine the true value of the diamond that they intend to buy or sell. The typical process will be as follows:
a. The trader will enter the values of the various parameters of the diamond being sold/bought into the matrix.
b. The data entry can be manual or will be scanned into the system using a bar-code stored in a “smartcard” or through other means like a Radio Frequency Identification (RFID) tag.
c. When the data is entered into the system, the matrix will use these parameters to evaluate the true value of the diamond and then give it as an output to the trader.
d. The trader will then use this as the “true value” for his negotiations with the counter-party.
e. Once the sale is concluded, the trader will update the database with the diamond details, sale details (including the final sales price and the date of sale as well as the country where the diamond is sold).

Periodic Database update—The database will be updated on a regular basis (daily or weekly depending on the volume of transactions). During the update, the discount/premium values and regression coefficients (weightages for each of the parameter) will be updated based on the latest transactions (The database update will be flexible enough to increase or decrease the number of transactions to be considered for the update). This will ensure that the pricing mechanism incorporates the latest changes in demand and supply conditions as well as any changes in customer requirements.

Benefits of the invention—The matrix will provide a systematic and data-driven approach to determine the true value of a diamond. Some of the advantages of using the matrix would be as follows:

### I. For Trading Purposes

i. Determine the true value of a diamond based on its characteristics, thereby enabling the trader to extract the best value from a trade.
ii. Eliminate subjectivity in trading—the true value price will be system generated, and hence the company using the matrix will be able to define a standard pricing policy for its traders.
iii. The trader will be able to evaluate the best price that the diamond can fetch in various markets, thereby helping in determining the ideal time to complete a buy/sell transaction.
iv. Increase the transparency in the valuation of diamond stocks—this will be useful to companies who want to leverage the financial value of diamond stock with them.
v. Assist banking institutions in financing against diamond assets in a transparent manner.

### II. For Manufacturing Purposes

i. Help in deciding the manufacturing approach for a given diamond, based on its estimated true value.
ii. Help in setting price targets for manufacturing various diamonds, through an estimation of the potential characteristics of the manufactured diamond.
iii. Help small manufacturers in optimizing their price points without going through several layers.

### Exemplary Implementations

The present invention can be realized in hardware, software, or a combination of hardware and software. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form. The computer program can be a computer-readable medium product of any type. A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, CD-optical drive or disc and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer system to read such computer readable information.

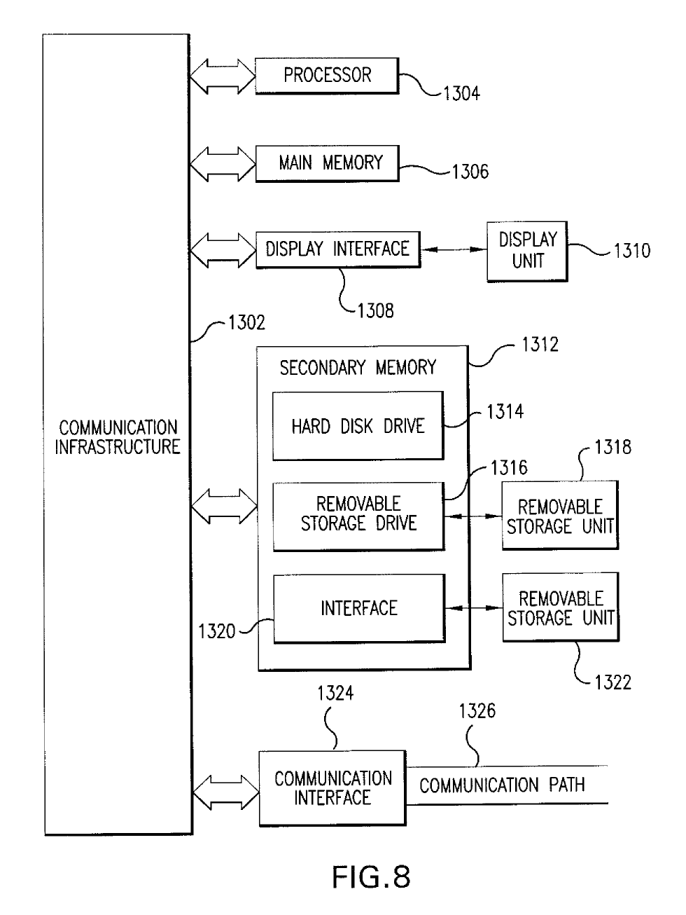

FIG. 8 is a block diagram of a computer system useful for implementing an embodiment of the present invention. The computer system includes one or more processors, such as processor 1304. The processor 1304 is connected to a communication infrastructure 1302 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 1308 that forwards graphics, text, and other data from the communication infrastructure 1302 (or from a frame buffer not shown) for display on the display unit 1310. The computer system also includes a main memory 1306, preferably random access memory (RAM), and may also include a secondary memory 1312. The secondary memory 1312 may include, for example, a hard disk drive 1314 and/or a removable storage drive 1316, representing a floppy disk drive, a magnetic tape drive, an optical disk drive, and more. The removable storage drive 1316 reads from and/or writes to a removable storage unit 1318 in a manner well known to those having ordinary skill in the art. Removable storage unit 1318 represents a floppy disk, magnetic tape, optical disk, and more which is read by and written to by removable storage drive 1316. As will be appreciated, the removable storage unit 1318 includes a computer usable storage medium having stored therein computer software and/or data.

In alternative embodiments, the secondary memory 1312 may include other similar means for allowing computer programs or other instructions to be loaded into the computer system. Such means may include, for example, a removable storage unit 1322 and an interface 1320. Examples of such may include a program cartridge and cartridge interface (such as that found in video game devices), a removable memory chip (such as an EPROM, or PROM) and associated socket, and other removable storage units 1322 and interfaces 1320 which allow software and data to be transferred from the removable storage unit 1322 to the computer system.

The computer system may also include a communications interface 1324.

Communications interface 1324 allows software and data to be transferred between the computer system and external devices. Examples of communications interface 1324 may include a modem, a network interface (such as an Ethernet card), a communications port, a PCMCIA slot and card, and more Software and data transferred via communications interface 1324 are in the form of signals which may be, for example, electronic, electromagnetic, optical, or other signals capable of being received by communications interface 1324. These signals are provided to communications interface 1324 via a communications path (i.e., channel) 1326. This channel 1326 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 1306 and secondary memory 1312, removable storage drive 1316, a hard disk installed in hard disk drive 1314, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory 1306 and/or secondary memory 1312. Computer programs may also be received via communications interface 1324. Such computer programs, when executed, enable the computer system to perform the features of the present invention as discussed herein. In particular, the computer programs, when executed, enable the processor 1304 to perform the features of the computer system. Accordingly, such computer programs represent controllers of the computer system.

Although the invention has been described in terms of specific details and embodiments, nevertheless changes and modifications will occur to persons skilled in the art, which do not depart form the spirit, scope and teachings above. Such changes and modifications are deemed to fall within the purview of the appended claims.

What is claimed is:

1. A method for evaluating a diamond comprising the steps of:
a. selecting a diamond to value,
b. determining the shape, size, color, clarity and cut of the selected diamond,
c. establishing a transaction database of data records of recent diamond transactions containing details of the shape, size, color, clarity and cut of the diamonds transacted and details of a plurality of other parameters of the diamonds transacted,
d. determining a base price based on a base/standard/index diamond,
e. calculating the applicable discounts/premium to be allocated for each of the parameters based on the parameter value for the diamond,
f. calculating a weightage for each parameter of the selected diamond from the weights database,
g. calculating the weighted total adjustment where discount/premium for each parameter is multiplied with the weightage associated with the parameter,
h. calculating a total adjusted price based on the discount/premium determined in step e, the weightage determined in step g and the base price determined in step d, and
i. outputting the calculated total adjusted price.

2. The method of claim 1 including the further steps of maintaining and updating a database of the discount/premiums.

3. The method of claim 1 including the further steps of maintaining and updating a database of the weightages.

4. The method of claim 1 including maintaining a matrix database for final pricing.

5. A method for determining a discount/premium for a diamond comprising the steps of:
j. establishing a transaction database of data records of recent diamond transactions containing details of the shape, size, color, clarity and cut of the diamonds transacted and details of a plurality of other parameters of the diamonds transacted,
k. for each parameter i, selecting from the transaction database, data records that substantially match the selected diamond for shape, size, color, clarity and cut, and all the other parameters in Table 1 with the exception of parameter i
l. From these records, for the parameter i, determining the average sales price Y for a diamond for the ideal value V(0) for the parameter i,
m. determining an average price Y(i) for a diamond with the selected parameter value of V(i),
n. calculating a discount/premium factor D(i) of the selected diamond using the formula
D(i)=(Y−Y(i))/Y
o. Calculating the discount/premium with respect to the base/standard/index diamond using the formula
D′(i)=[D(i)−D(I)]/[1−D(I)] where D(I) is the discount/premium applicable to the base/standard/index diamond.
p. repeating steps k to o for each parameter i, and outputting the discount/premium factors.

6. The method of claim 5 including the further steps of calculating a weightage factor for each of the parameters V(i) determined in step k.

7. The method of claim 5 wherein the weightage factor is determined by regression analysis for each parameter V(i).

8. The method of claim 5 including the further steps of maintaining and updating a database of the discount/premium factors.

9. The method of claim 5 including the further steps of maintaining and updating a database of the weightage factors.

10. Apparatus for evaluating a diamond comprising:
I. means for establishing a transaction database of data records of recent diamond transactions containing details of the shape, size, color, clarity and cut of the diamonds transacted and details of a plurality of other parameters of the diamonds transacted,
ii. means for determining a base price of a selected diamond based on its shape, size, color, clarity and cut,
iii. means for determining the discount/premium for each parameter for a given diamond based on the parameter values for that diamond
iv. means for calculating a discount/premium for each parameter of the selected diamond,
vi. means for calculating a weightage for each parameter of the selected diamond,
vii. means for calculating a total adjusted price based on the discount/premiums determined, the weightages determined and the base price determined i, and
viii means for outputting the calculated total adjusted price.

11. The apparatus of claim 10 wherein the means for calculating a discount/premium for each parameter i of the selected diamond includes means of extracting records where all the other parameters—apart from parameter i, are equal or within a small specified range, determining the average sales price Y for a diamond for the ideal value V(0) of the selected parameter i, means for determining an average price Y(i) for a diamond with the selected parameter value of V(i), means for calculating a discount/premium D(i) of the selected diamond using the formula D(i)=(Y−Y(i))/Y, means for calculating the discount/premium of the selected diamond with respect to the base/standard/index diamond, using the formula D′(i)=[D(i)−D(I)]/[1−D(I)] where D(I) is the discount/premium of the base/standard i index diamond.

12. Apparatus of claim 10 wherein the means for calculating a weightage for each parameter of the selected diamond by regression analysis for each parameter i.

13. Apparatus of claim 10 further including means for updating a database of the discount/premiums.

14. Apparatus of claim 10 further including means for updating a database of the weightages.

15. Apparatus of claim 14 including means for calculating a weightage factor for each of the parameters V(i).

16. Apparatus of claim 15 wherein means are provided for determining the weightage factor by regression analysis for each parameter V(i).

17. Apparatus of claim 10 including means for maintaining and updating a database of the discount/premium factors.

18. Apparatus of claim 10 including means for maintaining and updating a database of the weightage factors.

19. Computer-readable medium containing program instructions for evaluating a diamond by establishing a transaction database of data records of recent diamond transactions containing details of the shape, size, color, clarity and cut of the diamonds transacted and details of a plurality of other parameters of the diamonds transacted, determining a base price of the selected diamond, calculating a discount/premium for each parameter of the selected diamond, calculating a weightage for each parameter of the selected diamond for which a discount/premium is calculated, calculating a total adjusted price based on the discount/premiums determined, the weightage determined and the base price determined, and outputting the calculated total adjusted price.

20. Computer-readable medium of claim 19 including program instructions for carried out the determination of discount/premiums—where for each parameter i, data records are selected where corresponding other values (apart from parameter i values) across data records are the same or within a small specified range and determining the average sales price Y for a diamond for the ideal value V(0) of the selected parameter i, determining an average price Y(i) for a diamond with the selected parameter value of V(i), calculating a discount/premium D(i) of the selected diamond using the formula D(i)=(Y−Y(i))/Y, and repeating for each additional parameter V(i) determined; and calculating the discount/premium D′(i) of the selected diamond with respect to the base/standard/index diamond using the formula, D′(i)=[D(i)−D(I)]/[1−D(I)] where D(I) is the discount/premium of the base/standard/index diamond.

21. Computer-readable medium of claim 19 including program instructions wherein the weightage is determined by regression analysis for each parameter i.

22. Computer-readable medium of claim 19 including program instructions for maintaining and updating a database of the discount/premiums.

23. Computer-readable medium claim 19 including program instructions for maintaining and updating a database of the weightages.
